(19) United States
(12) Patent Application Publication
(10) Pub. No.: US 2016/0165345 A1
(43) Pub. Date: Jun. 9, 2016

(54) PHANTOM CABLE ELIMINATION SYSTEM

(71) Applicant: FXCONNECTX, LLC, Holiday, FL (US)

(72) Inventors: Michael Vumbaco, Holiday, FL (US); James Arcidiacono, Holiday, FL (US)

(21) Appl. No.: 14/939,841

(22) Filed: Nov. 12, 2015

Related U.S. Application Data
(60) Provisional application No. 62/079,150, filed on Nov. 13, 2014.

(51) Int. Cl. H04R 3/00

(52) U.S. Cl. CPC H04R 3/00; H04R 2420/07

(57) ABSTRACT

A system for eliminating cables. The system includes a transmitter including an external input and a RF transmitter module; and a receiver including an RF receiver module and an external output.

### CROSS-REFERENCE TO RELATED APPLICATION(S)

The present application claims priority to and the benefit of U.S. Provisional Application No. 62/079,150, filed Nov. 13, 2014, entitled “PHANTOM CABLE ELIMINATION SYSTEM”, the entire content of which is incorporated herein by reference.

### FIELD

One or more aspects of embodiments according to the present invention relate to cable management, and more particularly to a system for eliminating cables.

### BACKGROUND

Cable management is inconvenient in various circumstances; thus, there is a need for a cable elimination system.

### SUMMARY

Aspects of embodiments of the present disclosure are directed toward a system for eliminating cables.

According to an embodiment of the present invention there is provided a system for transmitting data and audio applications, the system including: a transmitter including an external input and an RF transmitter module; and a receiver including a RF receiver module and an external output.

According to an embodiment of the present invention there is provided a transmitter further configured to accept audio, switch position, positional data, or midi data via an on an external input; and a receiver configured to present audio, switch position, positional data, or midi data to an external output.

According to an embodiment of the present invention there is provided a transmitter including multiple RF transmitter modules with the ability to manually or automatically select audio, switch position, positional data, or midi data on each external input; and a receiver configured to present audio, switch position, positional data, or midi data to each external output as received from transmitter.

### BRIEF DESCRIPTION OF THE DRAWINGS

These and other features and advantages of the present invention will be appreciated and understood with reference to the specification, claims, and appended drawings wherein:

FIG. 1A is a block diagram of a setup using cables;

FIG. 1B is a block diagram of a setup with cable runs eliminated, according to an embodiment of the present invention;

FIG. 1C is a block diagram of a setup with cable runs eliminated, according to an embodiment of the present invention;

FIG. 1D is a block diagram of a setup with cable runs eliminated, according to an embodiment of the present invention;

FIG. 2A is a block diagram of a transmitter, according to an embodiment of the present invention;

FIG. 2B is a block diagram of a receiver, according to an embodiment of the present invention;

FIG. 3A is a set of two panel layout diagrams, according to an embodiment of the present invention;

FIG. 3B is a set of two panel layout diagrams, according to another embodiment of the present invention;

FIG. 4 is a schematic diagram of portions of a transmitter and a receiver, according to an embodiment of the present invention;

FIG. 5 is a schematic diagram of portions of a cable elimination system, according to an embodiment of the present invention;

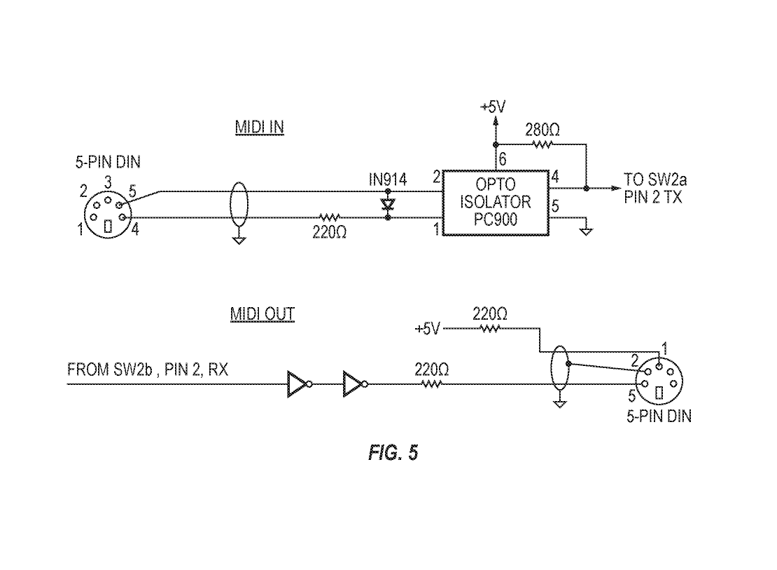

FIG. 6 is a block diagram of portions of a cable elimination system, according to an embodiment of the present invention;

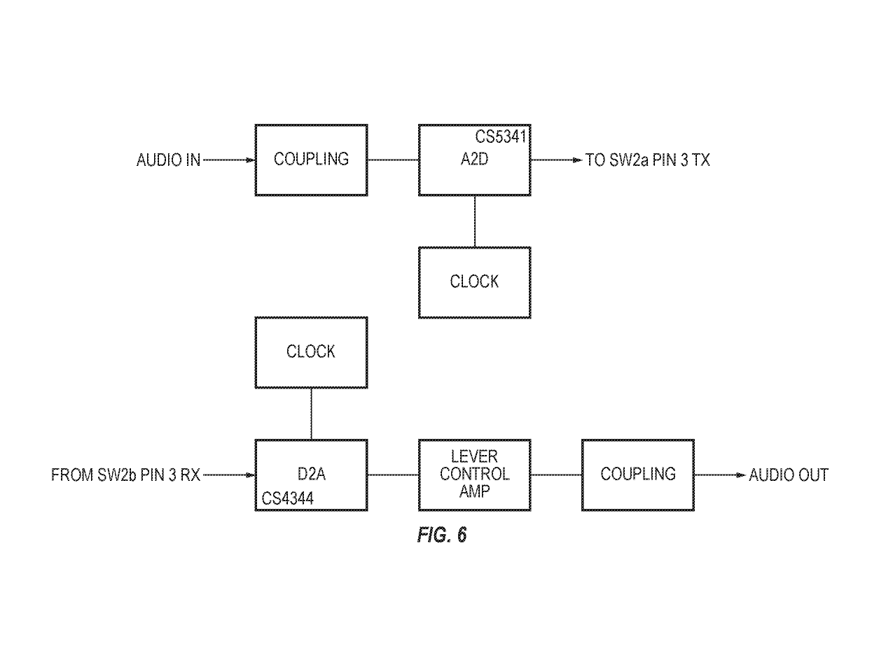

### DETAILED DESCRIPTION

The detailed description set forth below in connection with the appended drawings is intended as a description of exemplary embodiments of a cable elimination system provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

For many years people have struggled with managing audio and performance issues related to connection cables. Cable management has typically been solved by using combined cables within a snake, but certain types of signals, such as MIDI, have a distance limitation; and snakes, although they help reduce the total count of individual cables, are also prone to the same issues as single cables. Long, dangerous cable runs have simply been accepted as a “necessary evil.”

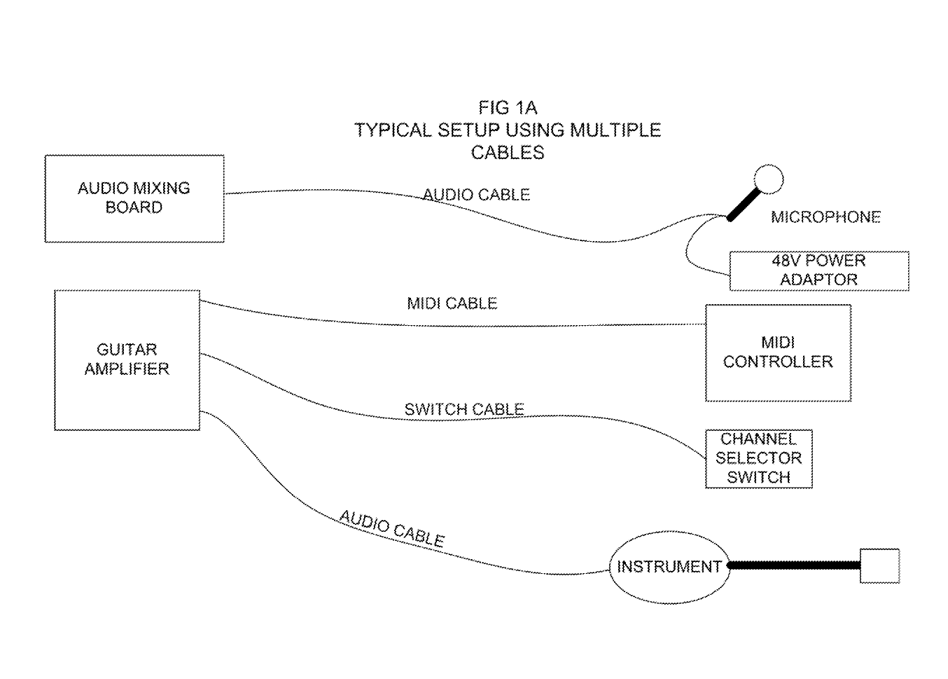

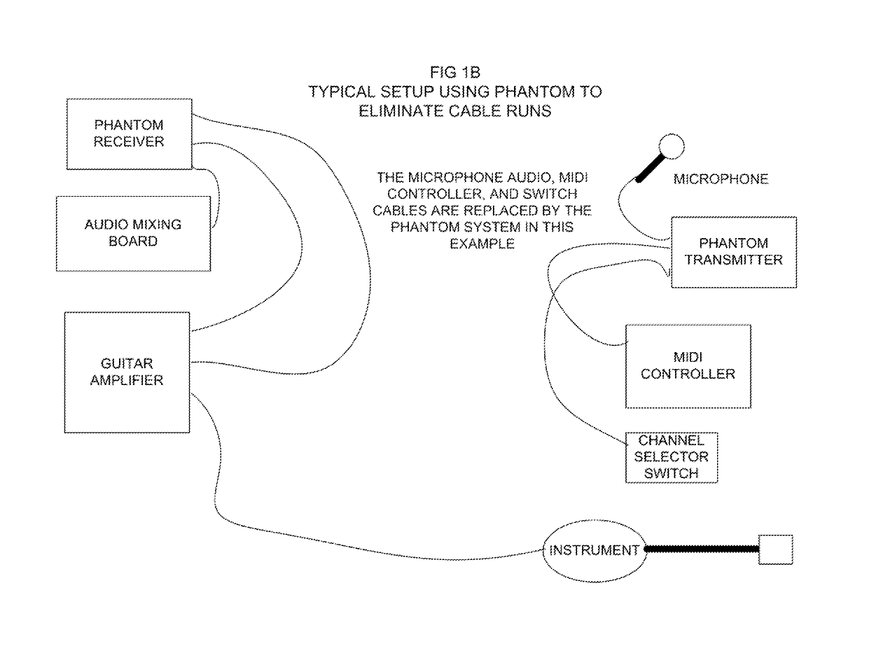

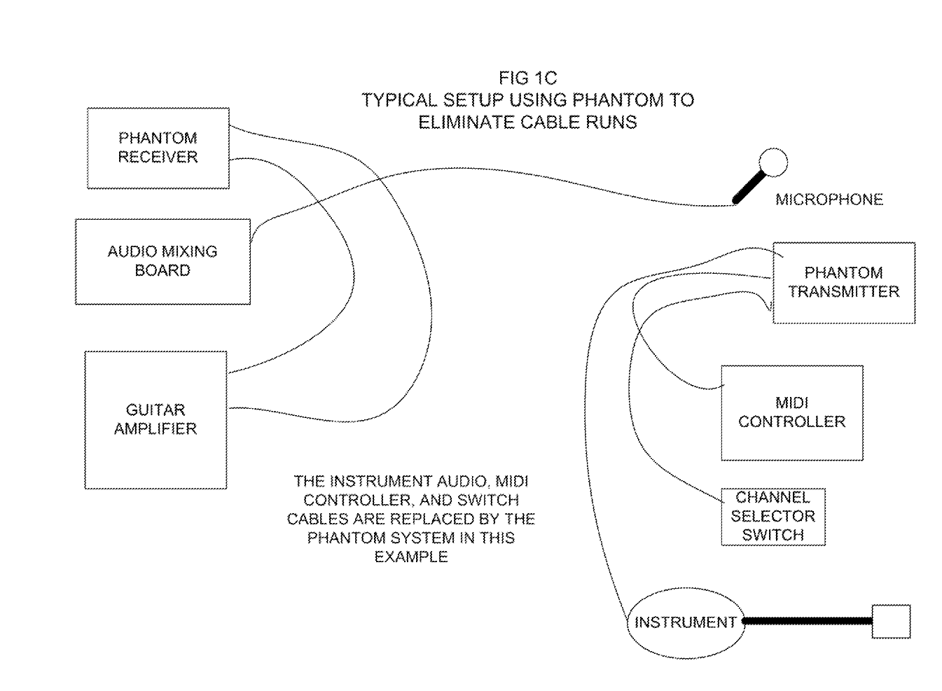

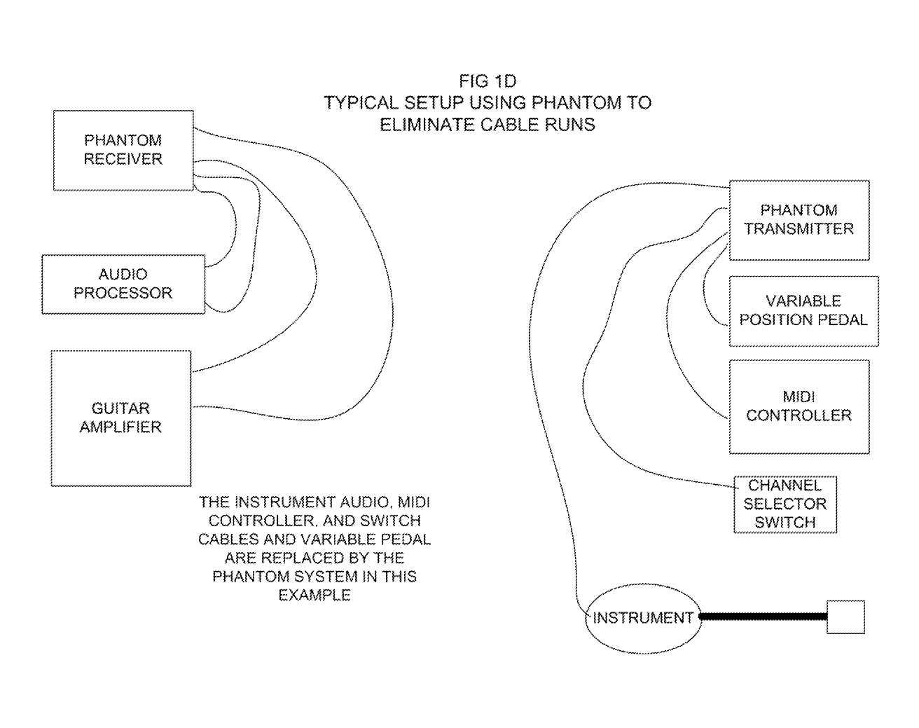

Cables, snakes, and similar, take time to set up, are prone to failure, are bulky, heavy, difficult to store, and are a safety concern to those working with and around them. A performer, DJ, studio engineer, and the like, may require multiple audio cables and control cables in order to perform effectively in a studio or live situation. A solution was needed to address these problems. FIG. 1A.

The Phantom Cable Elimination System was therefore designed to alleviate these problems.

The Phantom Cable Elimination System is a unique wireless solution that is intended to eliminate the need for multiple cable runs of various signal types and simplify the setup/takedown process all in a safe, secure, and highly streamlined two unit system solution.

The system (embodiments of which are referred to herein as the “Phantom System” or, equivalently the “Phantom Systems” or the “Phantom Cable Elimination System”) is powered by standard AC/DC wall adapters and is also available with optional internal rechargeable batteries.

The Phantom systems are designed to fit inside sturdy metal enclosures in order to reduce any externally induced RF interference and to provide a more rigid platform that is very rugged. Variants can also be enclosed in plastic/ABS, or similar, enclosures based on the intended operating environments and configuration offered.

The system is comprised of a Transmitter and Receiver set that is paired and synchronized with each other; however, it is also possible for multiple transmitters to be utilized with a single receiver.

The transmitter accepts various input signals and wirelessly transmits these to the receiver where they are presented on the outputs; effectively eliminating the need for multiple cables of various common, but specific, signal types. FIG. 1B, FIG. 1C, FIG. 1D.

The system in its most basic form is a single transmitter/receiver wireless RF system that has the flexibility to enable various types of communication to occur over the single wireless RF connection (which may include several channels) between the transmitter and receiver.

The input to the transmitter has circuitry that has been designed to accept audio, midi, and data-based (continuous or non-continuous) signals; which can be used for switching signals (on/off switching) or parameter control (light dimming, pedal or control surface position, etc.).

These front end input circuits are standard analog to digital circuits when using a digital RF module, or analog-based if using an analog RF module, as known to anyone in the art; however these are all designed and incorporated into a single system (The Phantom); hence the ability to eliminate the need for multiple cables carrying varying signal types.

The transmitter's input circuitry converts and codes these signals as such that they can be accepted and carried wirelessly based on the specs and requirements of a given off the shelf RF transmission module. Any type of fixed frequency or spread spectrum style RF module can be utilized for this purpose including VHF/UHF/Bluetooth; to name a few. The main limitation to this statement would be related to module data rate and latency. Modules with lower data rates and higher latencies would not be optimal for this application; as the human ear can easily distinguish audio signal delay and, as such, data-based signals (switch input as an example), where there is appreciable delay to what is being triggered will also be able to be heard.

Therefore, the minimum requirement is a module where the data rate and latency cannot be heard by the human ear; or at least to the extent where any delay or signal degradation is not objectionable by the user. A point of reference for this would be a minimum of 3 Mbits/sec data rate for uncompressed audio and a maximum of 20 ms of latency.

An example of multiplexed asynchronous is the variant where the audio, MIDI, positional, and switch inputs are multiplexed into a single continuous transmission stream. The microprocessor is coded as such to insert the various signals into fixed or variable length data packets within the stream delimited by start bits and stop bits.

An example of synchronous is the variant where the audio, MIDI, positional, and switch inputs use dedicated inputs for each signal, yet to ensure that the data and audio will appear simultaneous or near-simultaneous taking any data error corrections into account, a system clock is used to ensure the precision of data packet start/stop timing.

The receiver RF module receives the wireless transmission from the transmitter module and decodes the signal; which is then further processed by the receiver's circuits to convert the digital signal to analog and present it on the correct output jack.

It is also possible to use analog RF modules negating the need for analog to digital and digital to analog conversions. Again this is dependent upon the phantom's configuration.

The single input system as described above will be utilized by itself or in multiples in order to provide the ability to eliminate more cables. Hence, any number of cables can be eliminated by offering systems with additional quantities of inputs (transmitter/receiver pairs). Therefore, there is no realistic limit to the number of cables that can be eliminated; as long as there are enough inputs/outputs available within the system to support the required number of wires to be eliminated.

Configurations:

1. Single with selectable input. A single RF transmitter/receiver pair is utilized. The user selects the type of input/output desired; either audio or data-based.

2. Dual with selectable inputs. Two RF transmitter/receiver pairs (or a single ‘stereo style/L&R’ module) are utilized. The user selects the type of input/output desired for each input; either audio or data-based.

3. Quad with selectable inputs. This would simply be an embodiment of the “Dual” multiplied by two. Note: additional inputs are added by continuing with the above scenarios and adding in the required number of transmitter/receiver pairs.

4. Dedicated input systems. Systems where the inputs/outputs are fixed according to the intended end use. Example is a system comprised of 8 SPST inputs used to control on/off lighting or on/off power control of equipment.

5. Systems with multiple mixed input transmitters and one or more receivers.

6. Systems with a wireless body pack that can allow the instrument to also be included in the wireless system. I.e., the instrument depicted in FIGS. 1B, 1C, and 1D could be wirelessly linked to either the ‘transmitter’ or ‘receiver’ of a Phantom system. This embodiment would obviously require an added RF receiver module in the ‘receiver’ or the ‘transmitter’ to be able to receive signals from multiple transmitters.

7. Systems where the Phantom transmitter is integrated into a floor unit or pedalboard unit (Phantom Pedalboard).

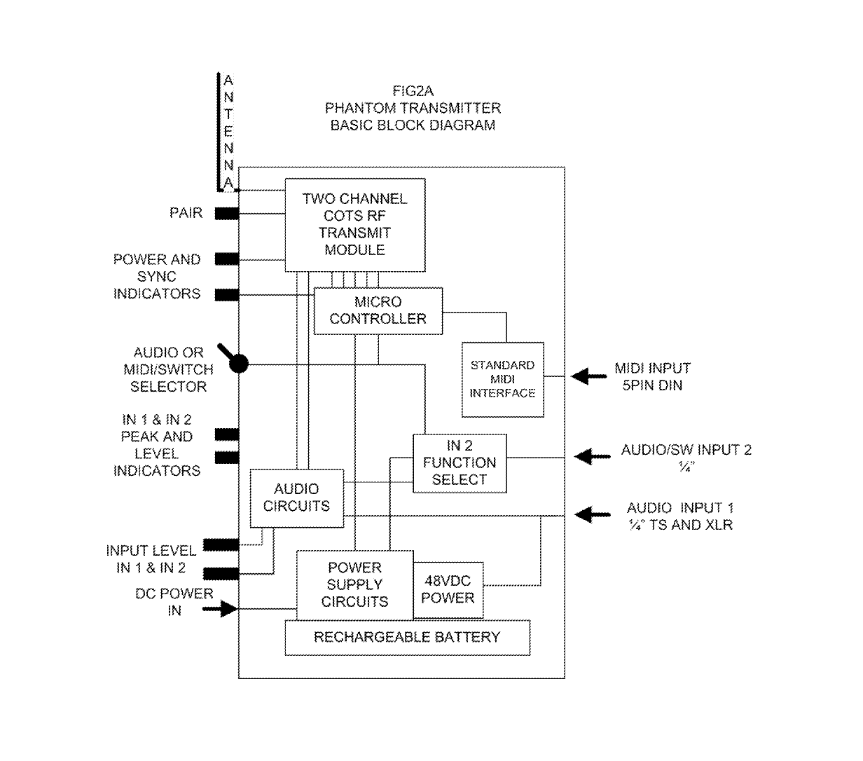

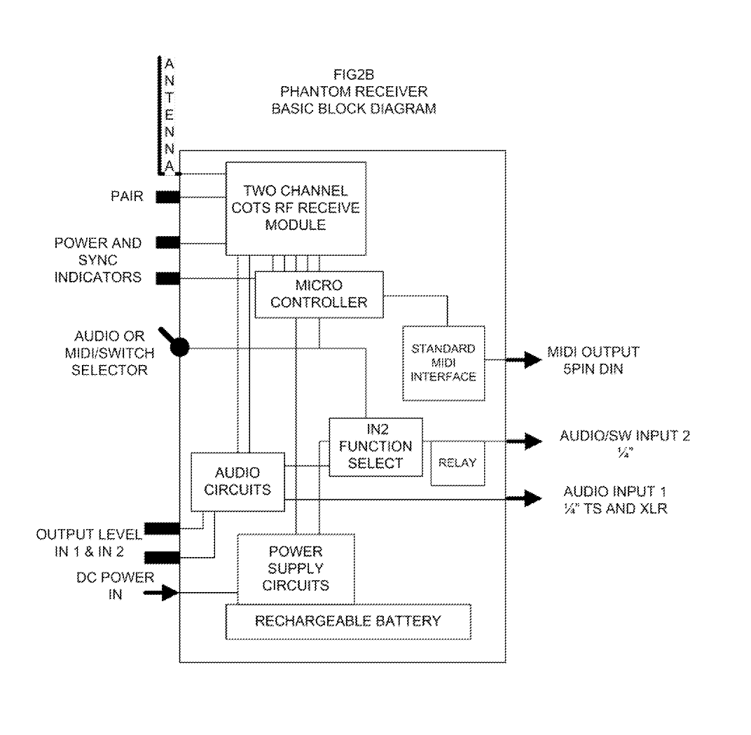

The Phantom system, in one embodiment, is a dual with selectable input system that utilizes a single 2-input/output Spread Spectrum RF module; one in the transmitter unit and one in the receiver unit. FIG. 2A and FIG. 2B.

This dual system provides dedicated audio use on the first input/output and a user-selectable input/output on the second. The second input can be set as Audio (A) or Midi & Switch (M/S). The selection feature is a switch on the unit that is set to the position of the given signal type that the user desires for the second input/output. When switched, the unit processor configures the input correctly by routing the input signal to the correct circuits within the unit. Routing is accomplished based on the type of input signal by means of relays, transistors, and digital routing means as known in the art.

When the second input is set to (A), both inputs can be utilized to eliminate two audio cables. As an example, one could be a microphone configured for tip/sleeve (an embodiment allowing for 48 vdc power on the ¼″ jack would use tip, ring, and sleeve) and the second input could be from an instrument or effects pedal allowing the performer to be completely wireless using only a single Phantom system.

When the second input is set to M/S, it will accept Midi signals into the midi jack and positional and switch data on the ¼″ jack utilizing all three of the ¼″ jack's connections (Tip, Ring, and Sleeve); effectively eliminating a total of three cables using only 2 RF inputs (or 4 cables if the 48 volt power embodiment is considered).

Positional data can be provided by any standard analog control surface or variable position pedal where position is derived via the use of a reference voltage (provided by the Phantom system) across a digital or analog potentiometer, slide resistor, or similar as known in the art. When set to the M/S position, the system microprocessor's Phantom specific programming will be utilized to monitor the reference voltage for changes (switch and/or positional) and ensure that the proper action is taken as appropriate (data sent to the transmit module along with control bits that are used by the receiver in order to decode and present the proper output).

The position is transmitted to the receiver where it is replicated using a digital potentiometer or electro-mechanically controlled analog potentiometer as known in the art.

Switch position, or ‘state’ (on or off), can be provided by using any standard SPST style switch. The Phantom system simply determines if the switch is open or closed using a reference voltage and sends this information to the receiver where it is replicated using the contacts of a relay. Therefore, when the SPST switch is actuated on the input (closed), the relay on the output closes. When the SPST switch is released (opened) the relay on the output opens.

Both inputs are effectively continuously transmitting, this is especially important for any audio as any intermittency can be easily distinguished by the human ear.

Bidirectional communication is utilized on embodiments where a signal needs to be returned to the source for validation purposes (validate that the signal made it to its destination (i.e. an LED illuminates on the transmitter as indication). The second input when set to M/S will be also be continually transmitting, but will also be monitoring the M/S data ports for changes at the maximum rate that the system processor will allow. Changes are immediately sent to the receiver; which will occur when switching the SPST switch on and off rapidly as an example.

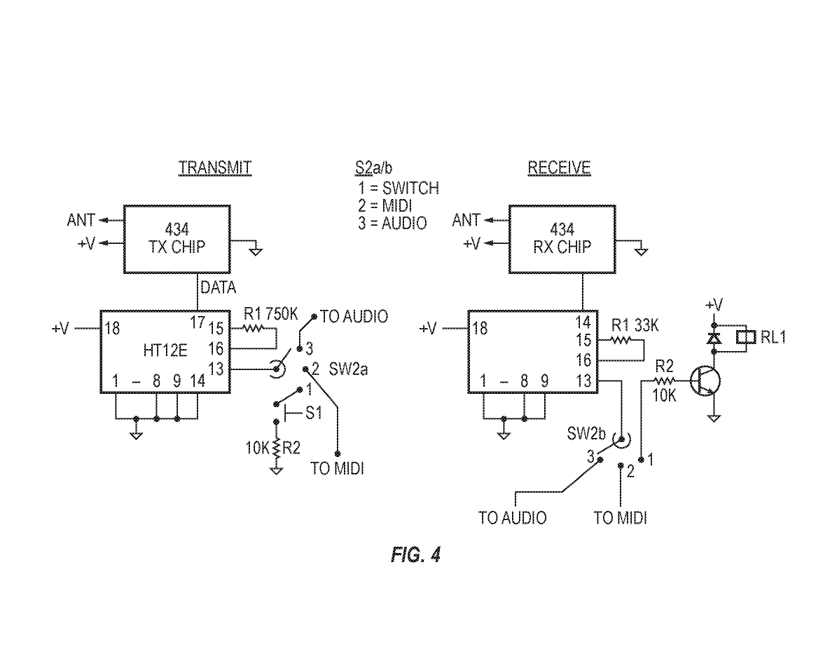

The M/S mode of operation is unique to the second input in this embodiment; as there are various circuits on the second input that the various signals are routed through according to signal type. A user could not physically actuate, for example, the SPST switch input, and at the same time be adjusting the positional input while playing an instrument, nor is it realistic to want to do so. Therefore, the processor prioritizes by activity. If the SPST switch input, for example, was rapidly switched on and off (as needed to set a delay time) it would be given priority while in use. Input data may be in a constant state of change while it is being used (as in on or off, positional data, etc. . . . ) therefore the processor will give the active data priority during use as long as there is a change sensed within a reasonable threshold. When no changes are sensed, the processor reverts to actively monitoring all second inputs for changes. Note that a manual switch version of this embodiment is shown on FIG. 4 as SW2a/b; with the notable exception of switch position 3.

When set to Audio mode, both inputs operate identically.

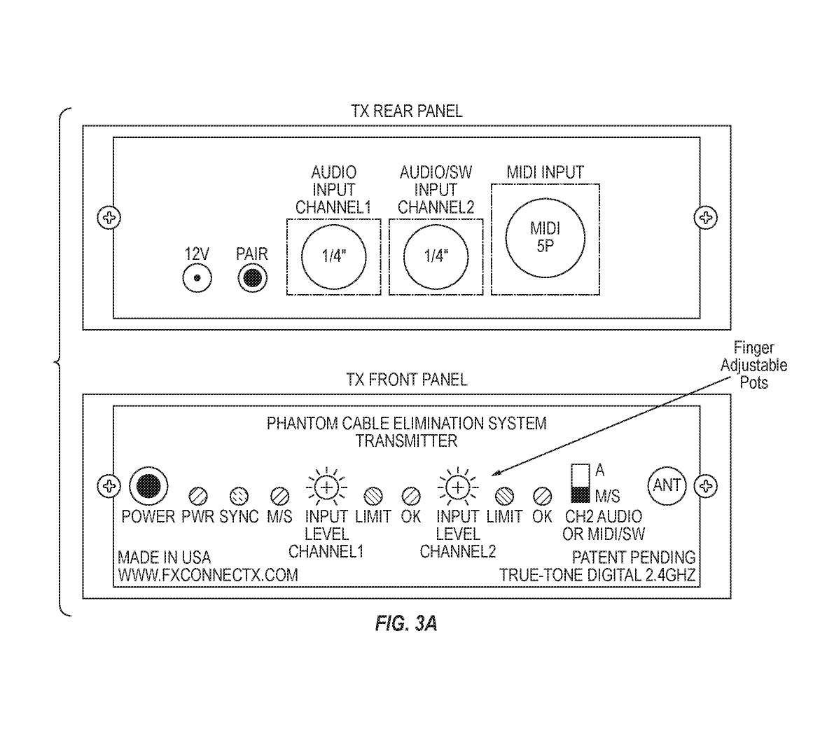

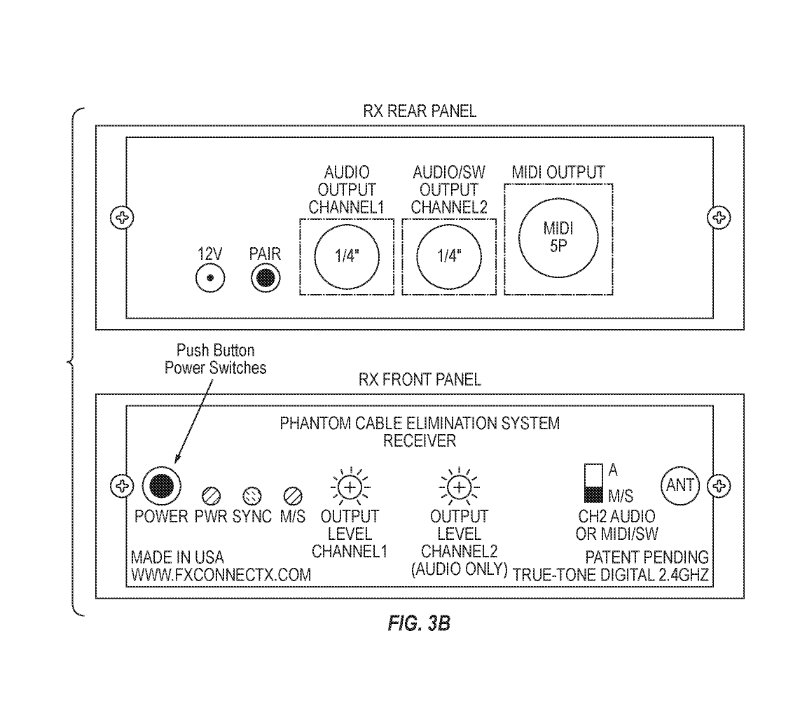

The following are the specific features of the twin input Phantom system: FIGS. 3A and 3B.

The system Contains 2 wireless RF inputs using a single wireless module within each unit

2 input system example

The first input is a dedicated audio port.

The audio input (on the transmitter) and output (on the receiver) have provisions for both balanced (XLR style jacks) and un-balanced (¼″ style mono Tip/Sleeve jacks).

The audio Input is able to provide 48 vdc phantom power via the XLR jack or ¼″ jack using tip, ring, and sleeve).

The audio Input and Output have level controls (potentiometers) and peak level indicators (LED's or meters).

The second input is either user selected to Audio with 48 vdc available, or set to M/S where the midi port will then be activated (deactivating the second audio port) and be capable of accepting any standard midi signal at the input and transmitting such to the receiver's midi output jack.

Therefore, when set to M/S the ¼″ audio style jack becomes active and can be utilized as follows:

As a switch input (on/off control) from a standard SPST style switch. The receiver utilizes a Normally Open relay to present the switch activity on the output of the receiver. This input/output uses the ¼″ jack's Ring and Sleeve connections.

As a variable-voltage style input that can be used as a parameter controller. The receiver will continuously replicate the transmitter's input level and present an analog representation of the input using a digital potentiometer, or similar technology, as known in the art. This input/output uses the ¼″ jack's Ring and Tip connections.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art. As used herein, the term “major component” means a component constituting at least half, by weight, of a composition, and the term “major portion”, when applied to a plurality of items, means at least half of the items.

As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present invention”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although exemplary embodiments of a cable elimination system have been specifically described and illustrated herein, many modifications and variations will be apparent to those skilled in the art. Accordingly, it is to be understood that a cable elimination system constructed according to principles of this invention may be embodied other than as specifically described herein. The invention is also defined in the following claims, and equivalents thereof.

What is claimed is:

1. A system for transmitting data and audio applications, the system comprising: a transmitter comprising an external input and an RF transmitter module; and a receiver comprising a RF receiver module and an external output.

2. A transmitter further configured to accept audio, switch position, positional data, or midi data via an on an external input; and a receiver configured to present audio, switch position, positional data, or midi data to an external output.

3. A transmitter comprising multiple RF transmitter modules with the ability to manually or automatically select audio, switch position, positional data, or midi data on each external input; and a receiver configured to present audio, switch position, positional data, or midi data to each external output as received from transmitter.
